(19) United States
(12) Patent Application Publication
(10) Pub. No.: US 2005/0199305 A1
(43) Pub. Date: Sep. 15, 2005

(54) Modular device assembly incorporating electronics therein

(76) Inventors: Randall M. Webber, Portgage, MI (US); Carl A. Scurio, Hamilton, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 11/030,651

(22) Filed: Jan. 6, 2005

Related U.S. Application Data
(60) Provisional application No. 60/552,234, filed on Mar. 11, 2004.

(51) Int. Cl. F16K 27/00

(52) U.S. Cl. 137/884

(57) ABSTRACT

A molded assembly includes a device having at least two states and a control having a lead or a contact. The control is adapted to actuate the device between the at least two states. A plastic body is molded about the control and is either molded about the device or forms the device. The control is at least partially encapsulated in the body, and the lead or contact for coupling to an external power supply for powering the control and the device.

This application claims priority from U.S. provisional application Ser. No. 60/552,234, filed Mar. 11, 2004, entitled MODULAR DEVICE ASSEMBLY INCORPORATING ELECTRONICS THEREIN, which is incorporated by reference in its entirety.

### BACKGROUND OF THE INVENTION

The present invention relates to modular assemblies and, more particularly, to molded modular assemblies.

### SUMMARY

The present invention provides a molded electronic assembly that includes a device and an electronic control. The electronic control is adapted to actuate the device between at least two states, for example, on and off states. A plastic body is molded about the device and the electronic control, with the device and the electronic control at least partially encapsulated in the body. The electronic control includes at least one lead or contact for coupling to an external power supply to power the electronic control.

In one aspect, the device comprises an electromagnet. The electromagnet includes at least one coupling surface, which is exposed for coupling to a ferrous member external of the body. For example, the molded electronic unit may be used as a door lock. Thus when powered and the electromagnet is magnetized, the assembly may be used to releasably lock, for example, a door in a doorframe.

In a further aspect, the coupling surface is provided at an external surface of the body. For example, the coupling surface may be substantially co-planar or flush with the external surface of the body.

In other aspects, the control includes a circuit board, which is at least partially encapsulated in the plastic body.

According to yet other aspects, the device comprises a light source. For example, the light source may comprise at least one light emitting diode, such as a high intensity light emitting diode.

In other aspects, the device may comprise a mechanical device, such as a valve, including a solenoid valve. For example, the valve may be selectively opened or closed by the electronic control.

According to another form of the present invention, a molded electromagnet assembly includes an electromagnet having at least one coupling surface and an electronic control. The electronic control is adapted to turn the electromagnet on or off to magnetize the coupling surface. A plastic body is molded about the electromagnet and the electronic control, with the electromagnet and the electronic control at least partially encapsulated in the body. The coupling surface of the electromagnet is exposed for coupling to a ferrous member external of the body. In addition, the electronic control includes at least one lead or contact for coupling to an external power supply to power the electronic control.

In one aspect, the electronic control includes at least one switch for selectively energizing the electromagnet.

In another aspect, the electromagnet has at least two coupling surfaces exposed for coupling to a ferrous member.

According to yet another aspect, the electromagnet comprises an E-shaped core and a coil, with the coil extending around a portion of the core. In this manner, the E-shaped core may provide three spaced coupling surfaces.

In yet another aspect, the electronic control includes a printed circuit board. Preferably, the printed circuit board is mounted to the electromagnet, for example, by an adhesive.

In another form of the invention, a method of manufacturing an electronic assembly includes providing a mold cavity, placing a device and its associated electronic control in the mold cavity, providing a lead or contact for the electronic control for coupling to an external power supply, and injecting a reaction injection molding plastic into the cavity to encapsulate at least part of the electronic control and the device to thereby form a molded modular electronic assembly.

In one aspect, the method further includes heating the electronic control and the device prior to placing the electronic control and the device in the mold cavity. For example, the electronic control and the device is preferably heated to a temperature in a range of about 125° F. to 140° F. prior to placing the electronic control and device in the mold cavity.

In other aspects, the reaction injection molding plastic is injected into the cavity when the electronic control and the device have a temperature of at least about 125° F.

In another form of the invention, a molded valve assembly includes a solenoid valve having at least one inlet, an outlet, a contact or lead for connecting to a power supply, and an electronic control, which is coupled to the contact or lead for selectively actuating the solenoid valve. In addition, the molded valve similarly includes a plastic body that is molded about the solenoid valve and the electronic control to at least partially encapsulate the solenoid valve and the electronic control wherein the molded valve assembly comprises a modular valve/electronic control assembly.

In one aspect, the electronic control includes a digital microprocessor. In a further aspect, the molded valve assembly includes at least one switch for providing input to the digital processor.

In another aspect, the molded valve assembly includes a circuit board, with the electronic control mounted to the circuit board. The circuit board is at least partially encapsulated in the plastic body. In addition, the molded valve assembly may include a light source, which is selectively actuated by the electronic control. For example, the light source may be mounted to the circuit board and may, for example, comprise a light emitting diode.

Accordingly, the present invention provides an electronic assembly that incorporates both a device and an electronic control for the device in a molded modular unit, which facilitates handling and installation of the device. The assembly may incorporate a wide variety of devices, such as electromagnets, lights, valves, or the like.

These and other objects, advantages, purposes, and features of the invention will become more apparent from the study of the following description taken in conjunction with the drawings.

### DETAILED DESCRIPTION OF THE DRAWINGS

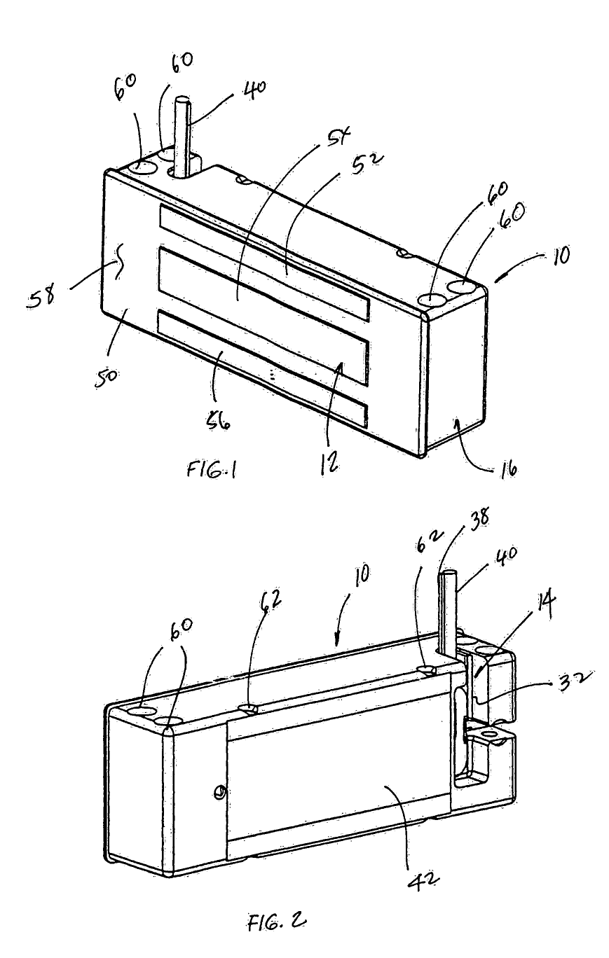

FIG. 1 is a perspective view of a molded modular electronic assembly incorporating an electronic control therein;

FIG. 2 is a rear perspective view of the molded modular electronic assembly of FIG. 1;

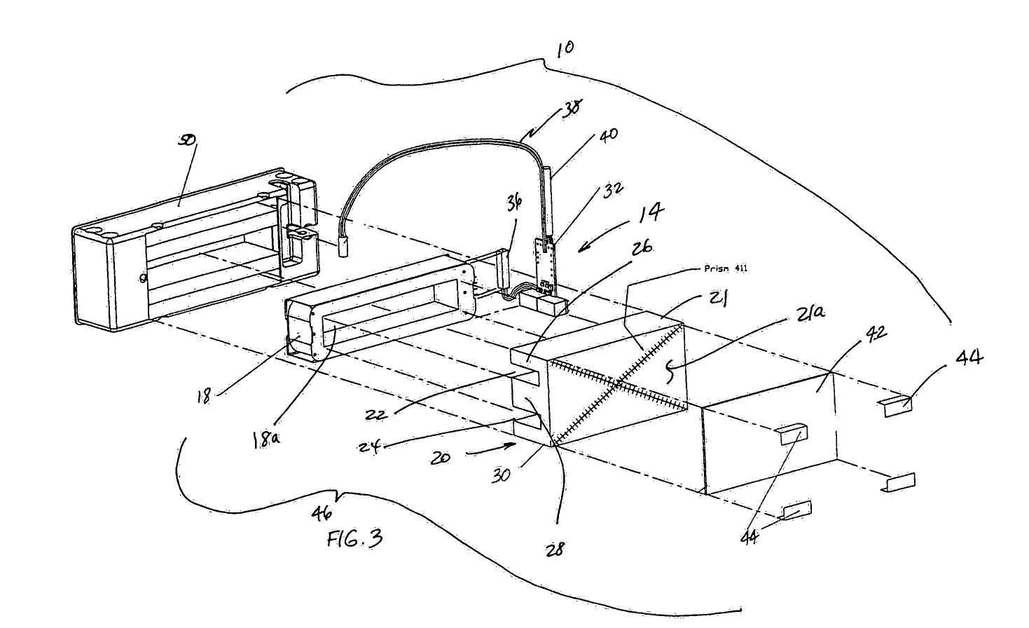

FIG. 3 is an exploded perspective view of the molded modular electronic assembly of FIGS. 1 and 2;

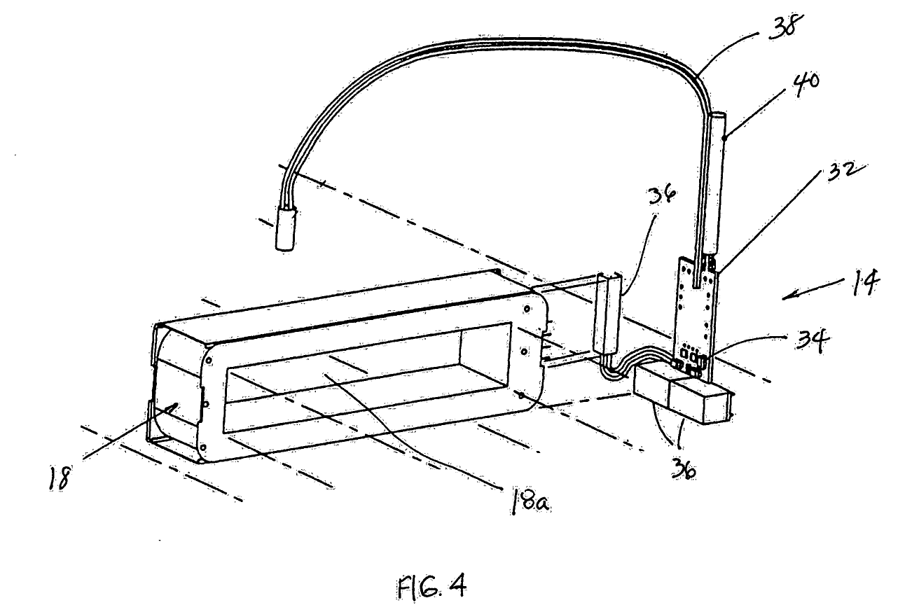

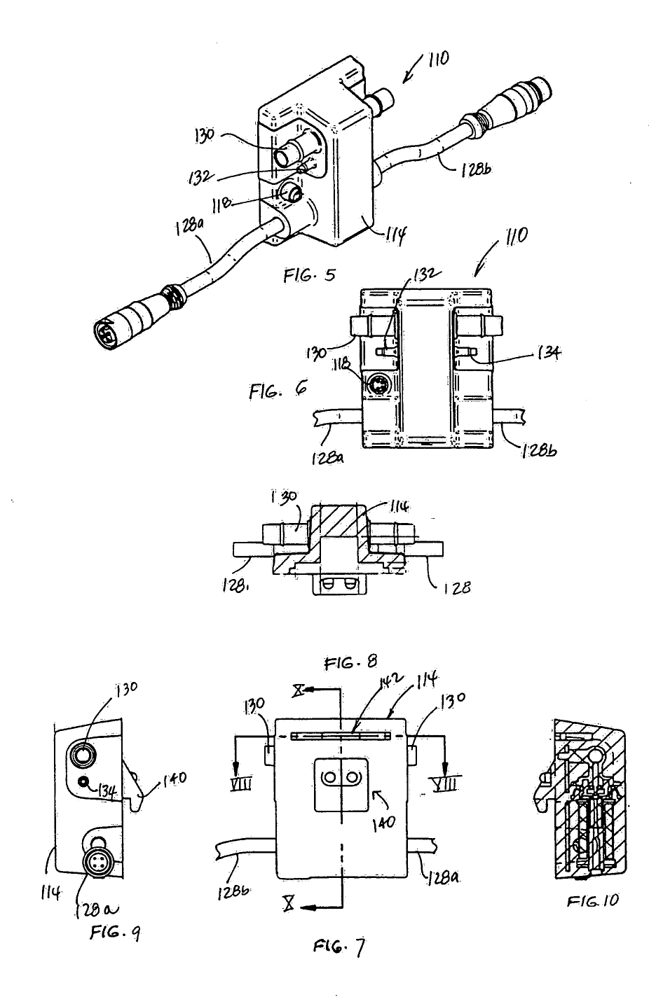

FIG. 4 is an enlarged perspective view of the device and electronic control of the modular assembly of FIGS. 1-3;

FIG. 5 is a perspective view of yet another embodiment of the molded modular electronic assembly incorporating an electronic control therein of the present invention;

FIG. 6 is a front elevation view of the molded modular electronic assembly of FIG. 5;

FIG. 7 is a back elevation view of the molded modular electronic assembly of FIG. 6;

FIG. 8 is a cross-section view taken along line VIII-VIII of FIG. 7;

FIG. 9 is a right side elevation view of the molded electronic assembly of FIG. 7;

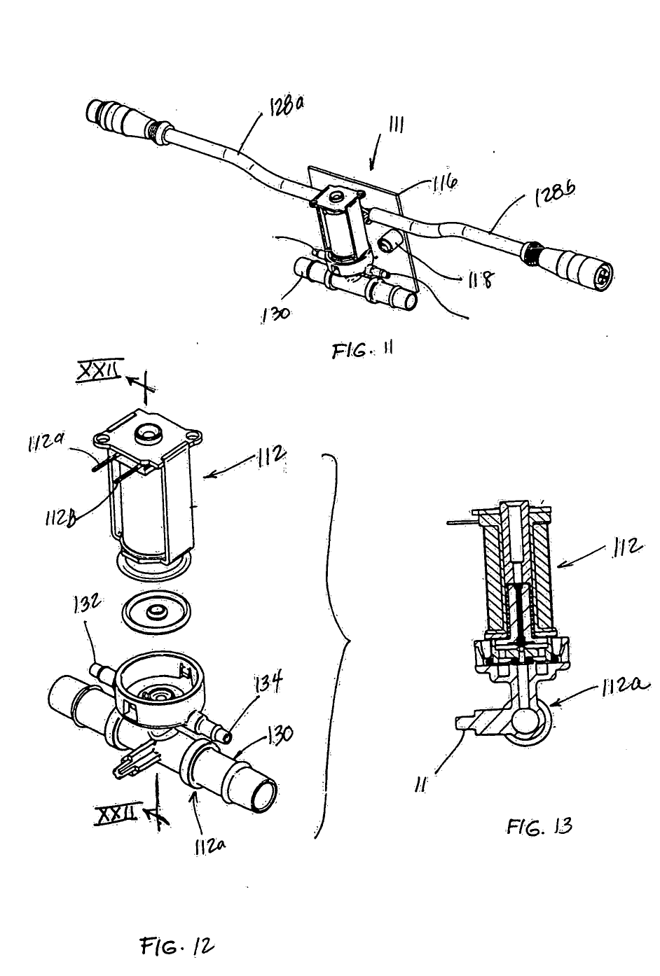

FIG. 10 is a cross-section view taken along line X-X of FIG. 7;

FIG. 11 is a perspective view of the modular electronic assembly of FIG. 5 prior to molding;

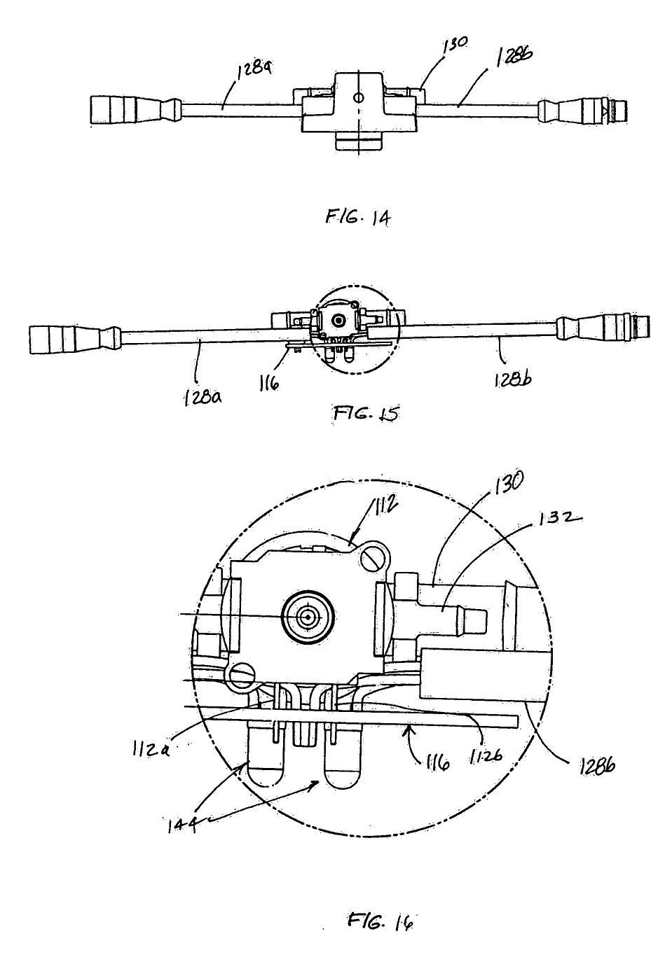

FIG. 12 is an exploded perspective view of the valve assembly of FIG. 11;

FIG. 13 is a cross-section view taken long line XIII-XIII of FIG. 12;

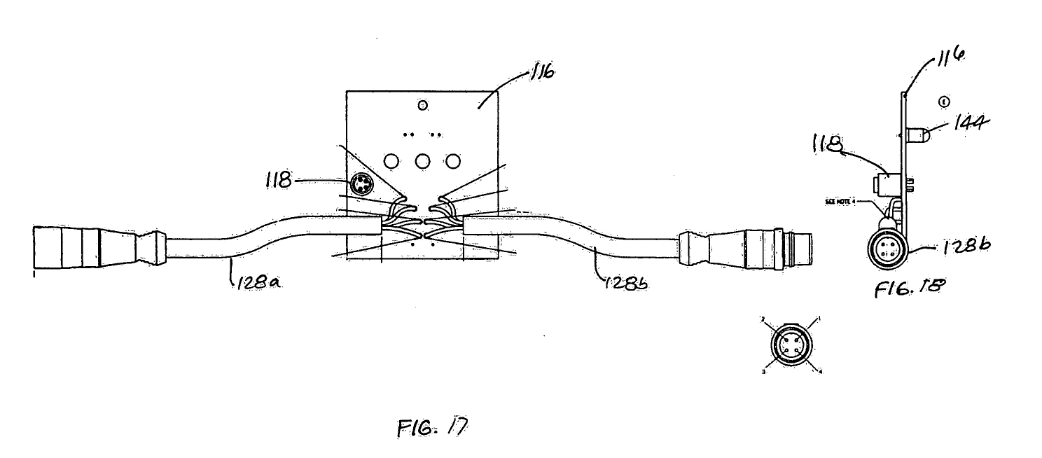

FIG. 14 is a side elevation view of the molded modular electronic assembly of FIG. 15;

FIG. 15 is a similar view to FIG. 14 of the modular electronic assembly prior to molding;

FIG. 16 is an enlarged detail of the connection between the valve assembly and the leads to the circuit board;

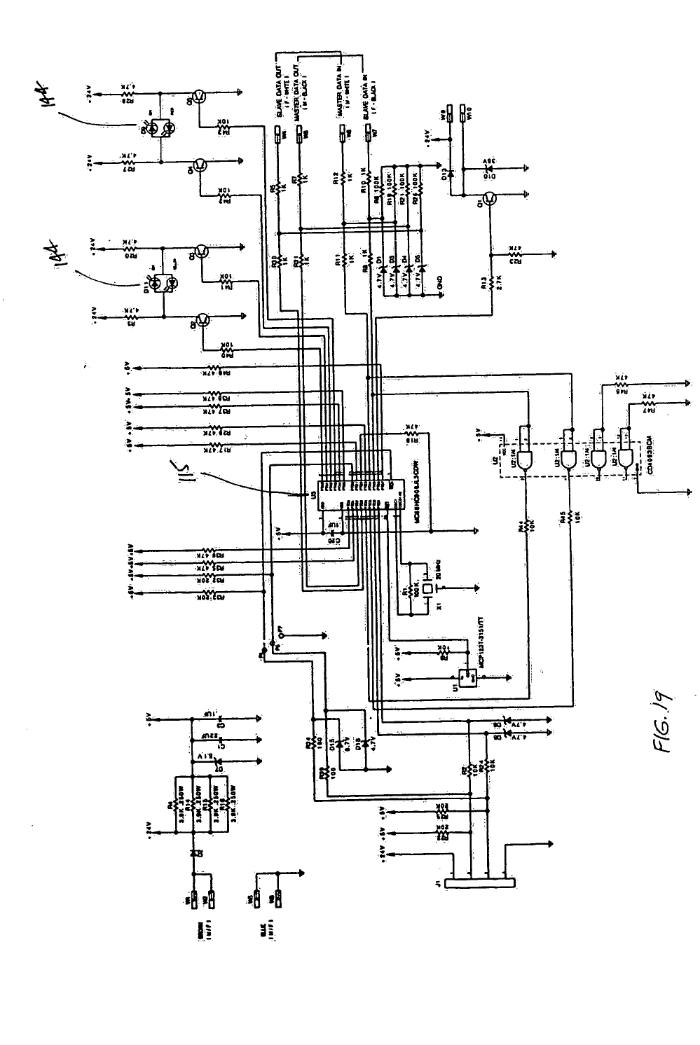

FIG. 17 is an enlarged elevation view of the circuit board of electronic control assembly of FIG. 11 with the valve removed for clarity;

FIG. 18 is a side view of the circuit board of FIG. 17;

FIG. 19 is a schematic drawing of the control circuitry;

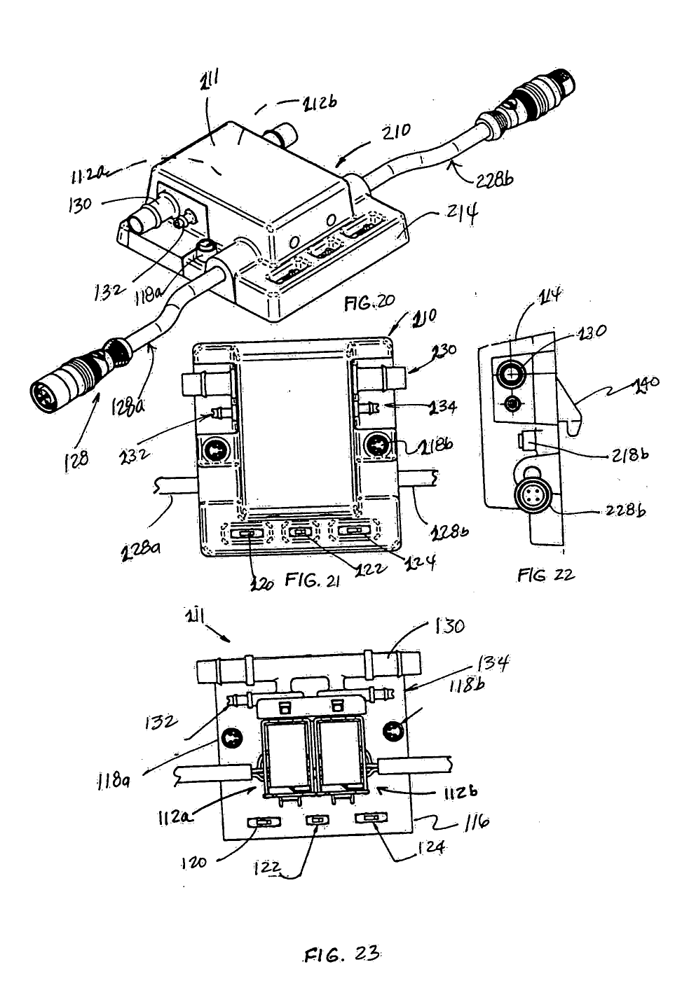

FIG. 20 is a perspective view of a second embodiment of a molded modular electronic assembly incorporating an electronic control therein;

FIG. 21 is a plan view of the molded modular electronic assembly of FIG. 20;

FIG. 22 is a side view of the molded modular electronic assembly of FIG. 21;

FIG. 23 is a similar view to FIG. 21 of the modular electronic assembly prior to molding;

FIG. 24 is a bottom plan view of the modular assembly of FIG. 20;

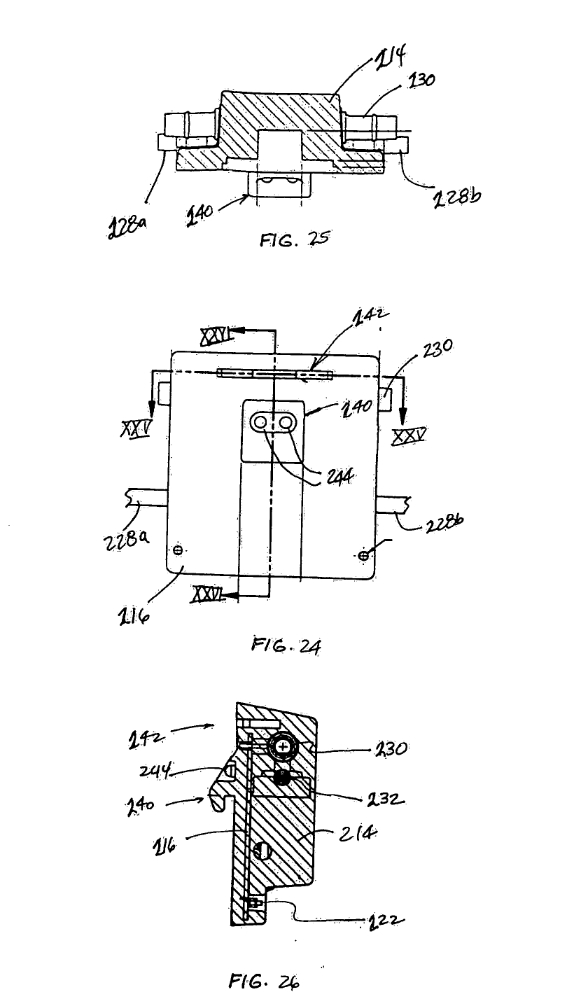

FIG. 25 is a cross-section view taken along line XXV-XXV of FIG. 24;

FIG. 26 is a cross-section view taken along line XXVI-XXVI of FIG. 24;

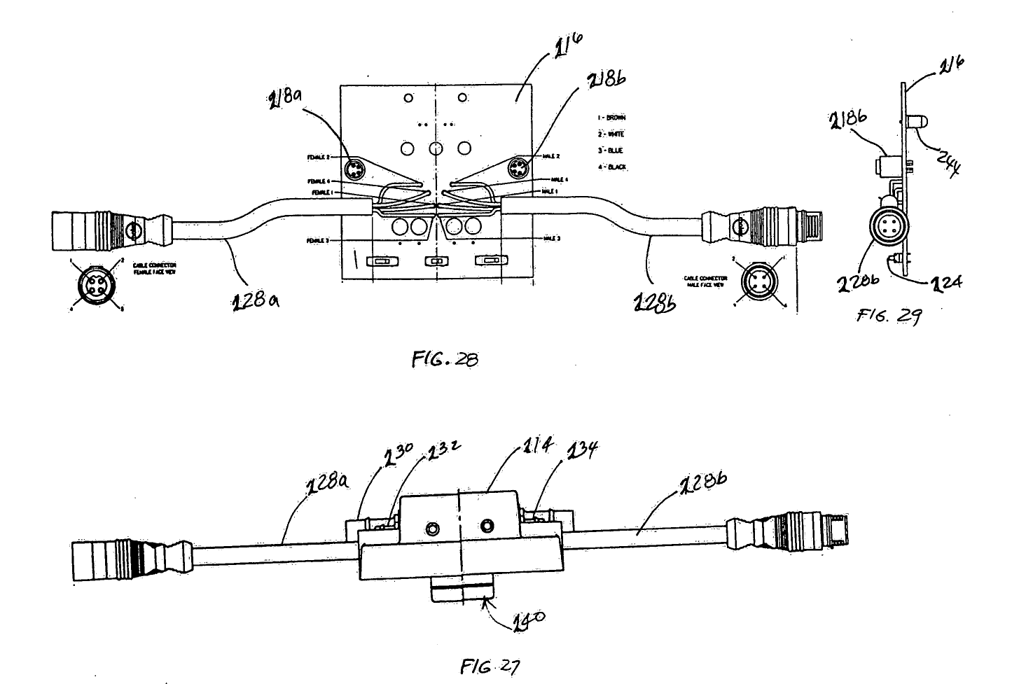

FIG. 27 is a another side view of the molded modular electronic assembly of FIG. 26;

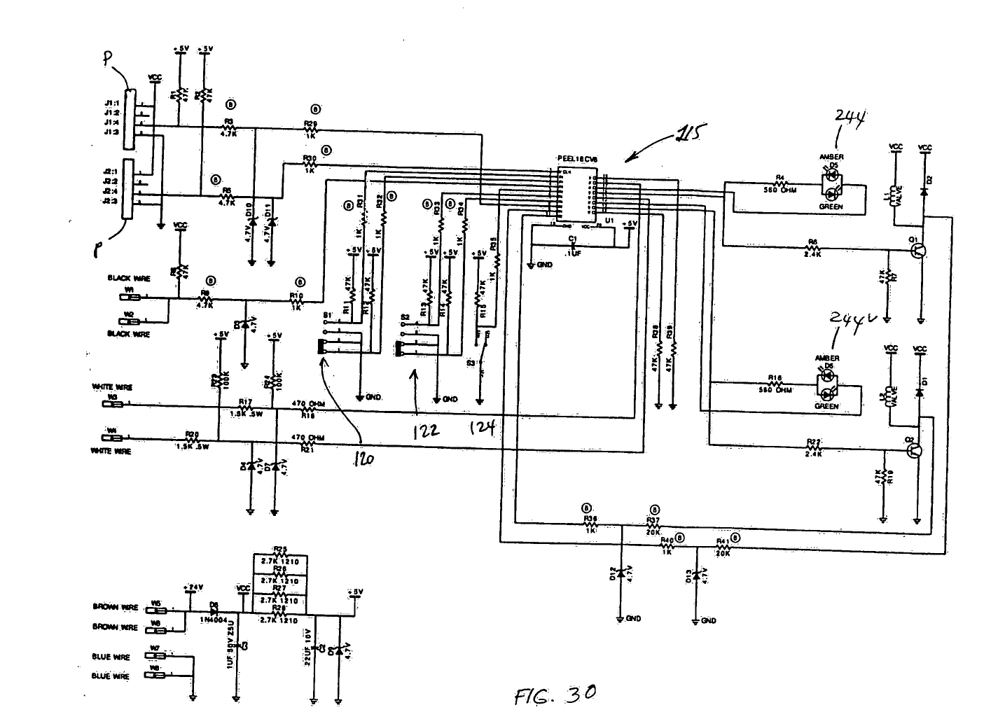

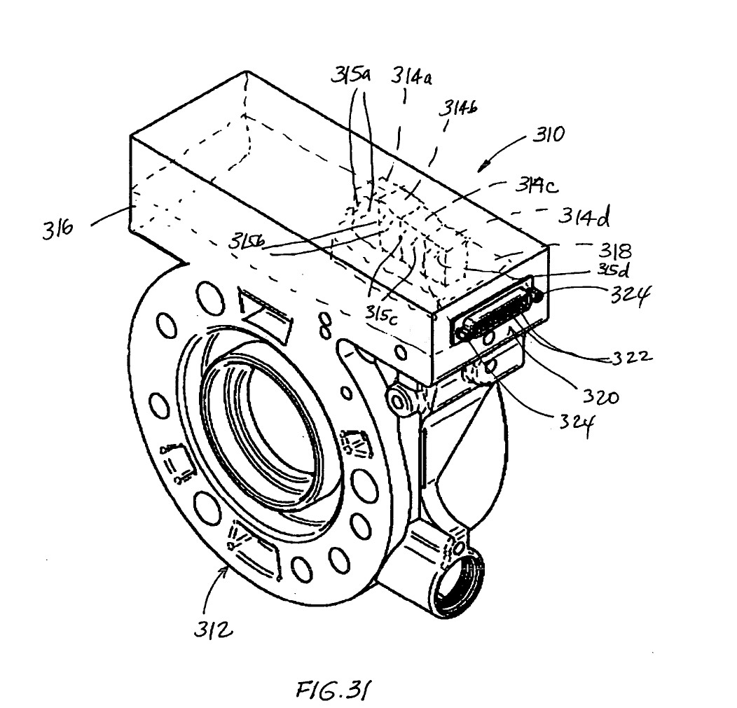

FIG. 28 is a view of the circuit board of the modular electronic assembly of FIG. 23, with the valve removed for clarity;

FIG. 29 is a side view of the circuit board of FIG. 28;

FIG. 30 is a schematic drawing of the electronic control circuitry of the electronic assembly;

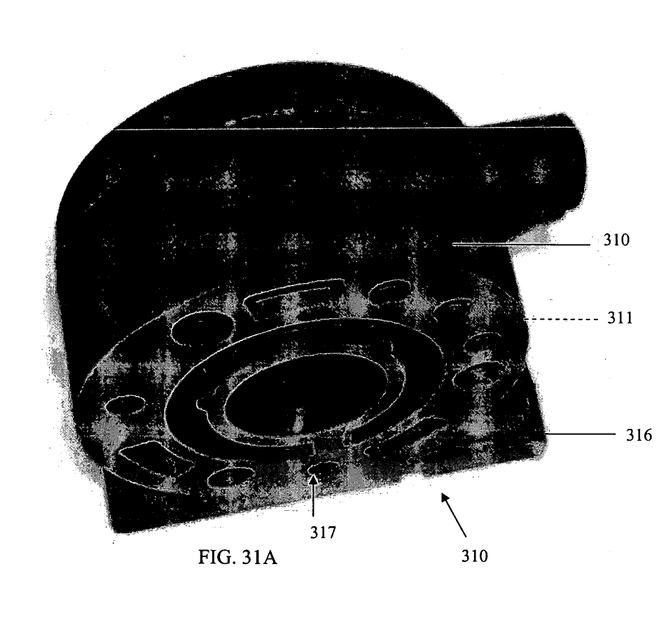

FIG. 31 is a perspective view of a modular manifold assembly of the present invention;

FIG. 31A is a bottom perspective view of the modular manifold assembly of FIG. 31;

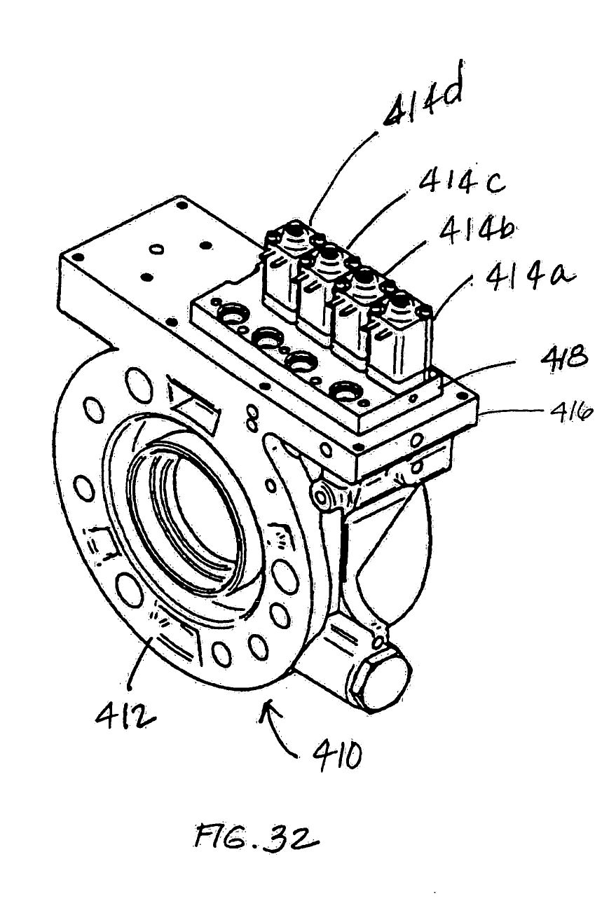

FIG. 32 is a perspective view of a second embodiment of a manifold assembly of the present invention;

FIG. 33 is a perspective view of the manifold of FIG. 32 with the solenoid valves removed for clarity;

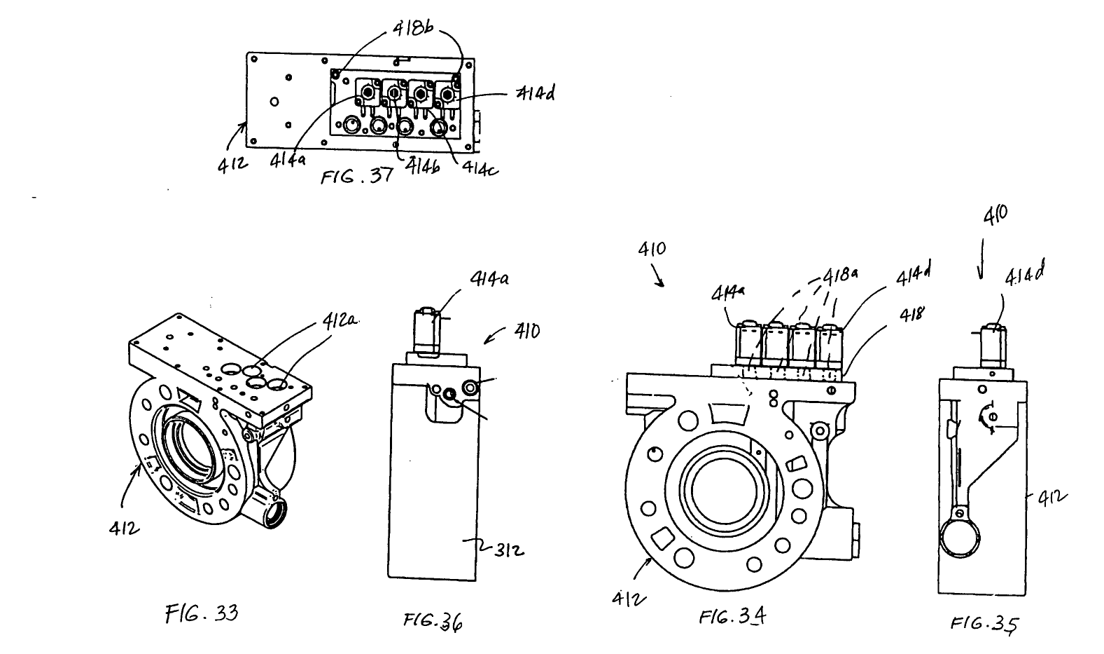

FIG. 34 is a front elevation view of the manifold assembly of FIG. 32;

FIG. 35 is a right side elevation view of the manifold of FIG. 32;

FIG. 36 is a left side elevation view of the manifold of FIG. 32; and

FIG. 37 is a top plan view of the manifold of FIG. 32.

### DETAILED DESCRIPTION OF THE PREFERRED EMBODIMENTS

Referring to FIGS. 1 and 2, the numeral 10 generally designates a modular electronic assembly of the present invention. As will be more fully described below, modular electronic assembly 10 includes a device that is actuatable between at least two states, for example, an on-state and an off-state, and an electronic control 14, which is adapted to change or actuate device 12 between its two states. In the illustrated embodiment, device 12 comprises an electromagnet, which is actuated by electronic control 14 to turn on—in other words to generate a magnetic field—and turn off in which the magnetic field is no longer generated. Device 12 and electronic control 14 are at least partially encapsulated in a body 16, which is formed by a reaction injection molded plastic. Thus, modular electronic assembly 10 comprises a molded assembly that is easier to handle and, further, easier to install.

For example, modular electronic assembly 10 is particularly suitable as a door lock. Assembly 10 may be mounted to a doorframe and aligned with a ferrous member, such as a ferrous plate, that is mounted to the door. In this manner, when the door is in, or close to, its closed position and assembly 10 is generally aligned with the ferrous member, the door may be locked upon the electromagnetic being energized. It should be understood that assembly 10 may have numerous other applications.

As best seen in FIG. 3, device 12 includes a coil assembly 18 and a core 20, which in the illustrated embodiment comprises an E-shaped core 21 with a plurality of spaced arms 26, 28, and 30. E-shaped core 21 may be formed from a solid block or may be formed from a plurality of stacked E-shaped ferrous plates. The E-shaped plates are secured together, for example, by an adhesive, such as a super-bond adhesive. Coil assembly 18 comprises a generally rectangular looped-shaped coil, which has a central opening 18a. Coil 18 is positioned in the spaces 22 and 24 formed between arms 26, 28, and 30 of E-shaped member 21. In this manner, central arm 28 extends into central opening 18a of coil 18.

Electronic control 14 is electrically coupled to coil assembly 18 to thereby power coil 18. Referring to FIG. 4, electronic control 14 includes a printed circuit (PC) board 32, which includes one or more resistors 34, relays 36, and a switch 36 and which is electrically coupled to the windings of coil assembly 18. In addition, circuit board 32 includes one or more electrical leads 38 for coupling to an external power supply source. Though it should be understood that circuit board 32 may include contacts for coupling to external logic and/or a power source. In addition, circuit board 32 preferably includes a cable 40 for coupling to external logic for controlling the delivery of power to coil assembly 18 and/or to allow communication between the external logic control and components mounted on PC board 32.

Referring again to FIG. 3, mounted to a rear surface 21a of E-shaped member 21 is a backing plate 42. Backing plate 42 comprises a ferrous plate and provides a magnetic shield to effectively terminate the magnetic field generated in core 20 at backing plate 42. Backing plate 42 is secured to rear surface 21a, for example, by an adhesive, such as LOCTITE Prism 411.

To assemble assembly 10, coil assembly 18, as previously noted, is mounted to E-shaped member 21. Back plate 42 is then secured to E-shaped member 21 by an adhesive. Preferably, to assure the securement of backing plate 42 to E-shaped member 21, additional securement means, such as tape 44 may be used to secure plate 42 to E-shaped member 21. Switch 36 and circuit board 32 may be mounted to coil assembly 18 before or after being mounted to E-shaped member 21. Preferably, circuit board 32 and hence switch 36, along with its other components, are secured to coil assembly 18 by an adhesive. Once coil assembly 18, core 20, and backing plate 42 are assembled as a pre-assembled unit 46, given the mass of E-shaped member 21, pre-assembled unit 46 is preferably heated prior to molding. For example, pre-assembled unit 46 is preferably heated to a temperature of at least about 125° F. and a maximum temperature of about 150° F., and more preferably, in a range of about 125° F. to 140° F. After heating, pre-assembled unit 46 is placed in a mold cavity into which a reaction injection molding plastic is injected to thereby form electronic assembly 10. After a period of time to allow at least partial curing, assembly 10 is removed from the cavity and allowed to cool to allow the set-up process to complete. Though it should be understood that the molded assembly may be left to fully cure in the mold cavity, however, this would tend to slow the production cycle down.

The reaction injection molded plastic is injected into the mold cavity at a temperature in a range from about room temperature, such as approximately 70° F., to 200° F. The reaction injection molded plastic, further, may be injected under pressure in a range of atmospheric pressure up to 300 psi. Suitable reaction injection molded plastics include cross-link polyurethanes, such as the resin components available from Cross-Linked Technology under the part numbers XPD1643/XID1638. Preferably, the reaction injection molded plastic is not injected into the mold cavity unless the preassembled unit 46 has reached a temperature of at least about 25° F.

Referring again to FIGS. 1 and 2, when molded, the reaction injection molded plastic forms a body 50, which at least partially encapsulates device 12 and, further, electronic control 14. As noted above, in the illustrated embodiment, device 12 comprises an electromagnet with one or more coupling surfaces 52, 54, and 56 that become magnetized when coil assembly 18 is powered. Coupling surfaces 52, 54, and 56 are exposed to allow assembly 10 to be used, for example as a lock or a coupler or the like. Preferably, coupling surfaces 52, 54, and 56 are located at an exterior surface 58 of body 50 and, further, are preferably co-planar or substantially flush with exterior surface 58. Coupling surfaces 52, 54, and 56, however, may be extended from body 50. Optimally, body 50 is molded with a plurality of mounting openings 60 and 62, which allow body 50 to be mounted to a structure, such as a doorframe or other similar structure, including non-stationary structures.

Molded electronic assembly 10 may be used in a wide variety of applications and provides a modular assembly that incorporates both a device to be actuated and the electronic control for actuating the device in a single, self-contained modular assembly. To deliver power and signals to circuit board 32, lead 38 and cable 40 are extended from body 50 to allow hookup to an external power supply and/or logic control. Alternately, electronic assembly 10 may include a socket into which a cable and/or a power lead may be inserted for coupling to the circuit board. It should be appreciated that circuit board 32 may incorporate thereon various logic circuitry, with cable 40 providing signals to the various logic circuitry mounted on circuit board 32. Alternately, circuit board 32 may incorporate thereon receivers so that the control of the various logic circuitry on circuit board 32 may be achieved through remote communication, such as RF communications or the like. Furthermore, in some applications, assembly 10 may incorporate an on-board power supply, which may be rechargeable, for example, or replaceable, so that unit 10 is completely self-contained.

Furthermore, while described in reference to an electromagnet, it should be understood, that device 12 may comprise other devices, including light sources, valves, or the like, such as described below.

Referring to FIG. 5, the numeral 110 generally designates another embodiment of the modular electronic assembly of the present invention. As will be more fully described below, modular electronic assembly 110 comprises a zone control module 111 that is suitable for use in a conveyor system to control to adjacent zones of a conveyor by way of pneumatic actuators, such as described in commonly owned patent application Ser. No. 10/383,890, filed Mar. 7, 2003, which is incorporated by reference in its entirety. As will be more fully described below, zone control module 111 is encapsulated in a housing 114 to facilitate the handling and installation of the control module.

Referring to FIGS. 11-13, zone control module 111 includes a solenoid operated pneumatic valve 112 and a digital microprocessor (115, FIG. 19), which is mounted to a circuit board 116. In addition, zone control module 111 includes a photo-eye connector 118 for connecting microprocessor 115 to a photo-eye, which is mounted to the conveyor, for example. In addition, zone control module 111 may include one or more switches (not shown), which provide input to the microprocessor, as will be more fully described below. As described in the referenced application, each zone control module 111 is preferably communicably interconnected to an adjacent zone control module by control cables 128a, 128b, which are adapted for the transmission of digital information, including information from the optical sensors and, further, which supply power to the optical sensors as well as the zone control modules 111.

Solenoid valve 112 is fluidly connected to an airline 130 (FIGS. 6 and 11) and, further, includes an outlet 132 for fluid connection to a pneumatic actuator of the conveyor system and an exhaust port 134.

As best seen in FIGS. 11, 15, and 16, cable portions 128a and 128b connect to circuit board 116 on which the microprocessor is mounted. Similarly, photo-eye connector 118 is mounted to circuit board 116 and, further, is interconnected to the microprocessor to provide input to the microprocessor.

Referring again to FIG. 12, solenoid valve 112 is powered by the microprocessor, which processes the information in a conventional manner, such as an 8-bit processor, with each byte conveying information as to the type of information processed. As described in the reference application, when the photo-electric beam from the photo-eye is interrupted, the zone control module associated with the photo-eye sends a signal to the main computer via the microprocessor.

As noted above, zone control module 111 may include one or more switches, which may be used to select a function for the module. For example, one of the switches may be used to select the direction of the conveyor to which the module is being mounted. Other switches may be provided to select a mode of operation, for example, to turn the module on or off.

As best understood from FIG. 12, air is delivered to the pneumatic valve 112 by air line 130, which fluidly interconnects air line 130 with the actuators through outlet 132 in response to the microprocessor for selectively activating and deactivating the pneumatic actuator. In the illustrated embodiment, solenoid operated valve 112 includes a pair of leads (or contacts) for coupling the valve to the circuit board and to the microprocessor through the circuitry on the circuit board.

Once assembled, the circuit board and its various components are placed in a mold cavity into which the material forming encapsulation 114 is injected preferably using a reaction injection molding apparatus so that the temperature associated with the molding process does not exceed the maximum temperature rating of any of the components on the circuit board or associated electronic components encapsulated in the body, for example, 140° F. In this manner, the various electronic control componentry in the zone control module will remain functional after molding. For a suitable method of molding, reference is made to the first embodiment; however, in this application preheating provides no additional benefit.

As best seen in FIGS. 5 and 6, when encapsulated, air line 130 projects outwardly from the housing formed by the encapsulation along with outlet port 132 and exhaust port 134 and, further, photo-eye connector 118. Similarly cables 128a and 128b project outwardly from the housing to provide external coupling to the zone control module. In addition, any switches are preferably molded in a recessed portion of the housing; though, the switches may be surface mounted or post mounted.

Referring to FIGS. 7-10, housing 114 may incorporate mounting structures for mounting assembly 110. For example, housing 114 may include a hook 140 formed therein for mounting assembly 110 to, for example, a conveyor. Additional mounting features may include a hook and slot 142.

Referring to FIG. 19, as previously noted, zone control module 110 includes a microprocessor 115, which receives input from a photo-eye associated with a zone of a conveyor through connectors 118. In addition, microprocessor 115 may be in communication with one or more light sources 144, such as LED's, to selectively power the light sources, for example to indicate when the module is actuated.

Referring to FIGS. 20 and 21, the numeral 210 generally designates another embodiment of the modular electronic assembly of the present invention. In the illustrated embodiment, the modular electronic assembly 210 comprises a dual zone control module 211, similar to the previous embodiment. In the illustrated embodiment, electronic assembly dual zone control module 211 is adapted for controlling two zones of a conveyor system, by way of two pneumatic actuators, such as is generally described in commonly owned patent application Ser. No. 10/383,890, filed Mar. 7, 2003, which is incorporated by reference in its entirety. As will be more fully described below, zone control module 211 is encapsulated in a housing 214 to facilitate the handling and installation of the control module.

Referring to FIG. 23, zone control module 211 includes a pair of solenoid operated pneumatic valves 212a and 212b and a digital microprocessor (215, FIG. 30), which is mounted to a circuit board 216. In addition, zone control module 211 includes a pair of photo-eye connectors 218a and 218b for connecting microprocessor 215 to a pair of photo-eyes, which are mounted to the conveyor, for example. In addition, zone control module 211 includes a plurality of switches 220, 222 and 224, which provide input to the microprocessor, as will be more fully described below. As described in the referenced application, each zone control module 211 is preferably communicably interconnected to an adjacent zone control module by control cables 228a and 228b, which are adapted for the transmission of digital information, including information from the optical sensors and, further, which supply power to the optical sensors, as well as the zone control modules 211.

Similar to the previous embodiment, solenoid valves 212a and 212b are fluidly connected to an airline 230 and, further, include outlets 232, 230 and 232 for fluid connection to the pneumatic actuators of a conveyor system, such as previously noted.

As best seen in FIG. 28, cable portions 228a and 228b connect to circuit board 216. Similarly, photo-eye connectors 218a and 218b are mounted to circuit board 216 and, further, are interconnected to microprocessor 215, to provide input to the microprocessor. Referring again to FIG. 12, solenoid valves 212a and 212b are powered by the microprocessor, which processes the information in a conventional manner, such as an 8-bit processor, with each byte conveying information as to the type of information processed, as described in the reference application. For example, when the photo-electric beam from one of the photo-eyes is interrupted, the zone control module sends a signal to the main computer via the microprocessor, which will then actuate the appropriate valve 212a, 212b.

As noted above, zone control module 211 includes a plurality of switches 220, 222, 224, which may be used to select a function for the module. For example, one of the switches, for example switch 222 may be used to select the direction of the conveyor to which the module is being mounted. The other switches, namely switches 220 and 224, may be used to select a mode of operation, for example, or provide off-on switches for the module.

As best understood from FIG. 23, air is delivered to the pneumatic valves by air line 230. The pneumatic valves fluidly interconnect the air line 230 with the conveyor actuators through outlets 232 and 234, which are controlled by microprocessor 215 and which selectively activates and deactivates the valves to thereby actuate pneumatic actuator(s).

Once assembled, similar to the previous embodiment, the circuit board and its various components are placed in a mold cavity into which the material forming housing 214 is injected preferably using a reaction injection molding apparatus so that the temperature associated with the molding process does not exceed the maximum temperature rating of any of the components of the circuit board or any associated electronic components encapsulated in the body, for example 140° F. In this manner, the various electronic control componentry in the zone control module will remain functional after molding.

As best seen in FIGS. 20 and 27, when encapsulated, air delivery line 230 projects outwardly from housing 214 formed by the encapsulation along with outlets 232 and 234 and, further, photo-eye connectors 218a and 218b. Similarly cables 228a and 228b project outwardly from the housing to provide external coupling to the zone control module. Switches 220, 222, and 224 are preferably molded in a recessed portion of the housing; though, the switches may be surface mounted or post attached.

Housing 214 may similarly incorporate mounting structures, such as a hook 240 formed therein for mounting the module to, for example the conveyor and/or a hook and slot 242.

Referring to FIG. 30, zone control module 210 includes a microprocessor 215 that receives input from a pair of photo-eyes P associated with the two zones controlled by zone control module 211 through connectors 218a and 218b. In addition, circuit board 216 may include one or more light sources 244, such as LEDs, which are in communication with microprocessor 215, which powers the light source to indicate, for example, when one or more valves of the module are actuated.

Referring to FIGS. 31 and 31A, the numeral 310 generally designates another embodiment of a molded assembly of the present invention. In the illustrated embodiment, molded assembly 310 comprises a molded manifold assembly with a manifold 312, such as a die cast manifold commercially available from Humphrey Products of Kalamazoo, Mich or a molded manifold, described below, and a plurality of solenoid operated valves 314a, 314b, 314c, and 314d, which are incorporated into manifold 312 to control the flow of air through the manifold. Manifold assembly 310 is particularly useful in railroad car applications for an electro-pneumatic train brake system.

As best seen in FIG. 31, manifold 312 comprises a molded manifold with an enlarged flange 316 in which inlets are formed and to which solenoid valves 314a, 314b, 314c, and 314d, which are separately commercially available under the Mizer name from Humphrey Products, are molded therewith so that they align with the respective inlets of the manifold and, further, at least partially encapsulated in the plastic material forming manifold 312 to thereby form a modular assembly that provides increased protection to its components from the environmental conditions associated, for example, with a railroad car, where components can be exposed to heat, dirt, and moisture. Manifold outlet 317 (FIG. 31A) is similarly formed during the molding process.

Manifold 312 is formed using a reaction injection molding process, similar to the process described in reference to the previous embodiments. Prior to molding, valves 314a, 314b, 314c, and 314d are commonly mounted on a carrier plate 318, which includes openings that are arranged to align with the inlets of manifold 312 located on flange 316 (such as illustrated in reference to manifold 412 below). Plate 318 and valves 314a, 314b, 314c, and 314d are then placed in a mold cavity that is configured to form the manifold.

For example, for a die cast manifold that has a considerable mass, it may beneficial to preheat before molding in which case, the manifold, valves 314a, 314b, 314c, and 314d and plate 318 may be preheated in a similar manner to the first embodiment prior to molding.

In the molded manifold application, valves 314a, 314b, 314c, and 314d and plate 318 are assembled and placed in the mold cavity and aligned so that the openings in the plate 318 align with the portion of the mold cavity that will form the inlets of the manifold. Once aligned, the mold cavity is injected with a reaction injection molding plastic to thereby form molded manifold assembly 310. After a period of time to allow at least partial curing, assembly 310 is removed from the cavity and allowed to cool to allow the set-up process to complete. Though it should be understood that the molded assembly may be left to fully cure in the mold cavity.

In this manner, valves 314a-314d and plate 318 are integrally formed with manifold 312, so that each of the respective valves is in selective fluid communication with the respective inlets of the manifold. In addition, prior to injecting the reaction injection molded plastic, the leads 315a, 315b, 315c, and 315d and the inlet and exhaust ports (not shown) of the valves are connected to an electrical/air connector 320, which provides external electrical connections 322 for the individual valves and also provides external air conduits by way of ports 324 for the inlet and exhaust ports of the valves. Connector 320 is similarly placed in the mold cavity prior to molding and aligned such that it is only partially encapsulated in the plastic so that its electrical connections 322 and ports 324 are accessible for hook up to an external power source and an external supply of pressurized air external to molded assembly 310.

Molded manifold assembly 310, therefore, comprises a self-contained modular assembly that provides increased protection to its component parts from the environmental conditions associated, for example, with a railroad car, where components can be exposed to heat, dirt, and moisture.

Referring to FIGS. 32-37, the numeral 410 generally designates another embodiment of the manifold assembly of the present invention. Assembly 410 includes a manifold 412 and a plurality of solenoid operated valves 414a, 414b, 414c, and 414d (FIGS. 32, 33, and 35-37), similar to the previous embodiment. In the illustrated embodiment, manifold 412 comprises a plastic body 416, which is formed using a reaction injection molding process, using a similar process described in reference to the previous embodiments. In this application, the valves are post attached, though it should be understood that they may be mounted to manifold 412 then encapsulated with the manifold by placing the pre-molded manifold into the mold cavity with the solenoid valves mounted to the manifold before injection molding the plastic into the mold cavity. In this application, the preheating of the components prior to molding is similarly preferable, though not required.

As best understood from FIGS. 33, and 35-37, valves 414a, 414b, 414c, and 414d, which are separately commercially available under the Mizer name from Humphrey Products, are commonly mounted on a carrier plate 418, which is then mounted to manifold 412. Plate 418 may comprise a metal plate or a plastic plate and includes a plurality of openings 418a (FIG. 34), which are arranged to align with the inlets 412a (FIG. 33) of manifold 412, and a second plurality of mounting openings 418b (FIG. 37) for securing plate 418, and hence valves 414a, 414b, 414c, and 414d, to manifold 412. In this manner, when valves 414a-414d and plate 418 are mounted to manifold 412, each of the respective valves is in selective fluid communication with the respective inlets 412a of the manifold.

Once assembled, as noted above, manifold 412, plate 418, and valves 414a, 414b, 414c, and 414d, may be placed in a mold assembly and injection molded using a reaction injection molding plastic to form a housing (not shown) around the valves and the manifold and at least partially around the connector (see previous embodiment) to form a modular self-contained unit.

While several forms of the invention has been shown and described, other forms will now be apparent to those skilled in the art. As noted above, device 12 may take many forms, including a static or stationary device or moving device, such as a valve. Therefore, it will be understood that the embodiments shown in the drawings and described above are merely for illustrative purposes, and are not intended to limit the scope of the invention, which is defined by the claims, which follow as interpreted under the principles of patent law including the doctrine of equivalents.

1. A molded assembly comprising:
a device having at least two states;
a control having a lead or a contact, said control being adapted to actuate said device between said at least two states; and
a plastic body being molded about said control and either being molded about said device or forming said device, said control at least partially encapsulated in said body, and said lead or contact for coupling to an external power supply for powering said control and said device.

2. The molded electronic assembly according to claim 1, wherein said device comprises an electromagnet having at least an on-state and an off-state.

3. The molded electronic assembly according to claim 2, wherein said electromagnet includes at least one coupling surface, said coupling surface being exposed for coupling to a ferrous member external of said body and being magnetized when said electromagnet is in said on-state, said control being adapted to actuate said electromagnet between said on-state and said off-state.

4. The molded electronic assembly according to claim 3, wherein said coupling surface is provided at an external surface of said body.

5. The molded electronic assembly according to claim 3, wherein said control includes at least one switch for energizing said electromagnet.

6. The molded electronic assembly according to claim 3, wherein said electronic control comprises a circuit board and at least one electronic device, said circuit board at least partially encapsulated in said body.

7. The molded electronic assembly according to claim 6, wherein said electromagnet comprises an E-shaped core and a coil, said coil extending around a portion of said core.

8. The molded electronic assembly according to claim 7, wherein said circuit board includes a lead, said lead extending from said body for coupling to an external control or power source.

9. The molded electronic assembly according to claim 8, wherein said circuit board is mounted to said electromagnet.

10. The molded electronic assembly according to claim 1, wherein said device comprises a light source, said light source having at least an on-state and an off-state, said light generating light when in said on-state.

11. The molded electronic assembly according to claim 1, wherein said device comprises a solenoid valve, said valve having at least an open state and a close state, said control comprising an electronic control for switching said solenoid valve between said open-state and said closed-state.

12. A molded valve assembly according to claim 11, wherein said electronic control includes a digital microprocessor.

13. A molded valve assembly according to claim 12, further comprising a circuit board, said microprocessor mounted to said circuit board, said circuit board at least partially encapsulated in said plastic body.

14. The molded electronic assembly according to claim 1, wherein said plastic body forms said device, said device comprising a manifold, said control comprising a solenoid valve, said solenoid valve including said lead or contact for coupling to an external power supply.

15. A valve assembly comprising:
a solenoid valve having at least one inlet and one outlet and a contact or lead for connecting to a power supply;
a manifold having at least one inlet, said solenoid valve in fluid communication with said inlet of said manifold; and
a reaction injection molding plastic body either (a) being molded about said solenoid valve to at least partially encapsulate said solenoid valve with said manifold to thereby form a modular valve and manifold assembly, or (b) forming said manifold.

16. A molded valve assembly according to claim 15, further comprising a plurality of solenoid valves, each of said solenoid valves associate with an inlet of said manifold, said reaction injection molding plastic body molded about said solenoid valves and said manifold.

17. A valve assembly according to claim 15, wherein said plastic forms said manifold and is molded about said solenoid valve to at least partially encapsulate said solenoid valve with said manifold to thereby form a modular valve and manifold assembly.

18. A method of manufacturing an electronic assembly comprising:
providing a mold cavity;
placing an electronic assembly in said mold cavity, the electronic assembly including a device and an electronic control for controlling the device, the electronic control having a lead or a contact for coupling to an external power source; and
injecting a reaction injection molding plastic into said cavity to encapsulate at least part of the electronic control and at least part of the device to form a modular electronic assembly.

19. The method of manufacturing an electronic assembly according to claim 18, further comprising heating at least the electronic control prior to placing the electronic control and the device in the cavity.

20. The method of manufacturing an electronic assembly according to claim 19, wherein said heating includes heating at least the electronic control to a temperature of at least about 125° F. and less than about 150° F. prior to said placing.

21. The method of manufacturing an electronic assembly according to claim 18, further comprising mounting the electronic control to the device prior to said injecting.
